(19) United States
(12) Patent Application Publication
(10) Pub. No.: US 2017/0267515 A1
(43) Pub. Date: Sep. 21, 2017

(54) SADDLE ANCHOR AND DETACHABLE STIRRUP SYSTEM

(71) Applicant: DUSTY ROAD SADDLERY AND REPAIR, LLC, Burnettsville, IN (US)

(72) Inventor: Linda Brisbin, Burnettsville, IN (US)

(21) Appl. No.: 15/463,367

(22) Filed: Mar. 20, 2017

Related U.S. Application Data
(60) Provisional application No. 62/310,168, filed on Mar. 18, 2016.

(51) Int. Cl. B68C 3/00; B68C 1/16

(52) U.S. Cl. CPC B68C 3/00; B68C 1/16; B68C 2003/0083

(57) ABSTRACT

A secondary stirrup saddle system includes a saddle anchor coupled to a saddle. A stirrup strap having a first end and a second end wherein said first end has a coupler. The stirrup strap can be removably coupled to the saddle anchor, wherein the stirrup strap has at least one stirrup coupling point. A stirrup have a coupler can be removably coupled to the coupling point on the stirrup strap. A user can then remove the stirrup strap from the saddle anchor after mounting the saddle.

### CROSS-REFERENCE TO RELATED APPLICATION

This U.S. patent application claims priority U.S. Provisional Application: 62/310,168 filed Mar. 18, 2016, the disclosure of which is considered part of the disclosure of this application and is hereby incorporated by reference in its entirety.

### FIELD OF THE INVENTION

This invention relates generally to secondary saddle stirrup devices and saddle attachments, and more particularly pertains to a new secondary stirrup system for providing an additional stirrup access point lower to the ground to aid a person, such as a child, in mounting a horse.

### BACKGROUND

Mounting a horse is often times a difficult task, particularly for children, shorter people or people having various physical limitations. The primary source of difficulty arises from the construction of a conventional saddle, which has a high stirrup into which the rider must place their left foot, and then step up and swing their right leg over the rump of the horse. The difficulty in getting up onto the horse is a deterrent that keeps many people from the enjoyment of horseback riding.

There are several solutions in the art to overcome the high first step into the conventional saddle stirrup. One solution is a small ladder or stepping stool upon which the rider can stand before swinging their foot into the stirrup, thereby reducing the size of the step. However, a ladder cannot be taken along for later use in case the rider dismounts. Also, a ladder or stool presents safety concerns in that the horse may accidentally knock it over, which may spook the horse or cause the horse to run or rear up before the rider is safely seated in the saddle. Ladders, or other mounting blocks, also may be dangerous if the horse moves or walks off prematurely while the person is on the ladder or block.

Another known solution to the high step stirrup problem is a stirrup attachment, which extends downwardly from the main stirrup. The stirrup attachment reduces the height that the rider must lift their left foot for placement into the attachment, but creates another problem in that the right leg must be thrown higher over the rump of the horse, which may be difficult. This also creates safety concerns, in that the rider may dig their right heel into the rump of the horse to gain leverage for getting into the saddle, which is uncomfortable for the horse and precarious for the rider.

Other known secondary stirrups have been provided in the prior art which hang from the saddle in front of the primary stirrup. However, with the lower secondary stirrup in front of a higher primary stirrup, the rider must cross their legs when mounting the horse. Therefore, a primary objective of the present invention is the provision for a saddle attachment for the use with a secondary stirrup system for a saddle that allows for easy mounting of the horse by people of all sizes and physical abilities.

Another objective of the present invention is the provision of a secondary saddle stirrup system which allows a person to easily step with both feet for quick and easy mounting of a horse. A further objective of the present invention is the provision of a secondary stirrup that is secured to a saddle behind the primary stirrup so that the secondary stirrup is behind and below the primary stirrup. A further objective of the present invention is the provision of a secondary saddle stirrup that has an adjustable length to accommodate various size riders. Another objective of the present invention is the provision of a saddle having an improved secondary stirrup that can be quickly and easily moved into a safe storage position after the rider has mounted the horse. Still another objective of the present invention is the provision of a saddle having a secondary stirrup that is economical to manufacture, easy to install, and safe and durable in use. These and other objectives will become apparent from the following description of the invention.

### BRIEF SUMMARY OF THE INVENTION

In one aspect, this disclosure is related to a secondary stirrup system for a saddle that allows an individual to safely and conveniently mount a saddle by providing them an easier route to the primary stirrup of the saddle. The system can include a saddle anchor configured to removably couple to a saddle, a stirrup strap configured to removably couple to said saddle anchor, and a stirrup configured to removably couple to said stirrup strap.

In another aspect, this disclosure is related to method of for providing an secondary saddle stirrup system comprising the steps of first providing a saddle anchor, stirrup strap, and a stirrup, coupling the saddle anchor to a saddle, coupling a stirrup strap to the saddle anchor, determining appropriate height to couple the stirrup to the stirrup strap, and coupling the stirrup to the stirrup strap.

Other objects and advantages of the invention will become apparent as the following detailed description is read with reference to the accompanying drawings.

### BRIEF DESCRIPTION OF THE DRAWINGS

The features and advantages of this disclosure, and the manner of attaining them, will be more apparent and better understood by reference to the following descriptions of the disclosed system and process, taken in conjunction with the accompanying drawings, wherein:

FIG. 1A is a perspective view of an exemplary embodiment of the secondary stirrup system attached to a portion of a saddle.

FIG. 1B is another perspective view of an exemplary embodiment of the secondary stirrup system coupled to a portion of a saddle.

FIG. 2A is an illustration of an exemplary embodiment of a saddle anchor of the secondary stirrup system.

FIG. 2B is an illustration of an exemplary embodiment of a stirrup strap of the secondary stirrup system.

FIG. 2C is an illustration of an exemplary embodiment of a stirrup attachment of the secondary stirrup system.

### DETAILED DESCRIPTION OF THE INVENTION

A detailed description of one or more examples is provided below along with accompanying figures. The detailed description is provided in connection with such examples, but is not limited to any particular example. The scope is limited by the claims, but numerous alternatives, modifications, and equivalents are encompassed. Numerous specific details are set forth in the following description in order to provide a thorough understanding. These details are provided for the purpose of example and the descriptions provided may be used for implementation according to the claims without some or all of these specific details. For the purpose of clarity, technical material that is known in the technical fields related to the examples has not been described in detail to avoid unnecessarily obscuring the description.

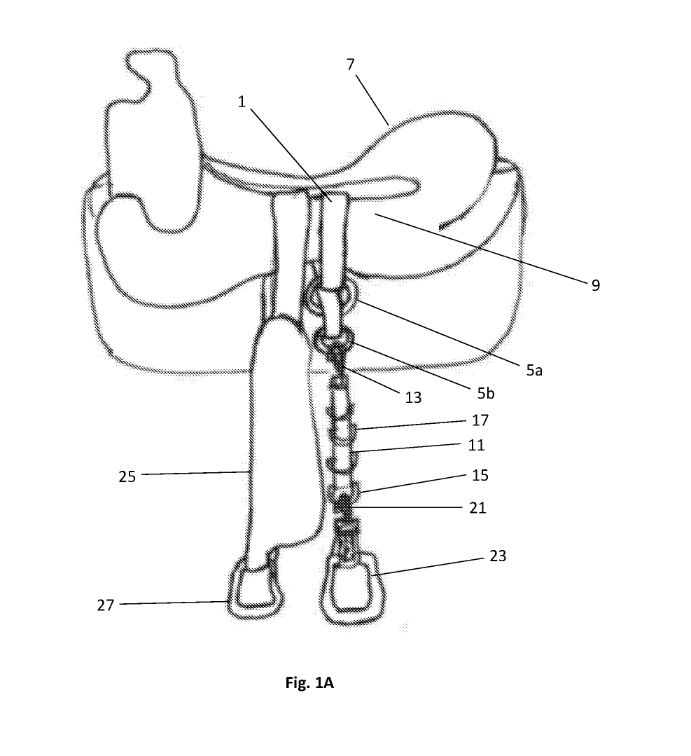

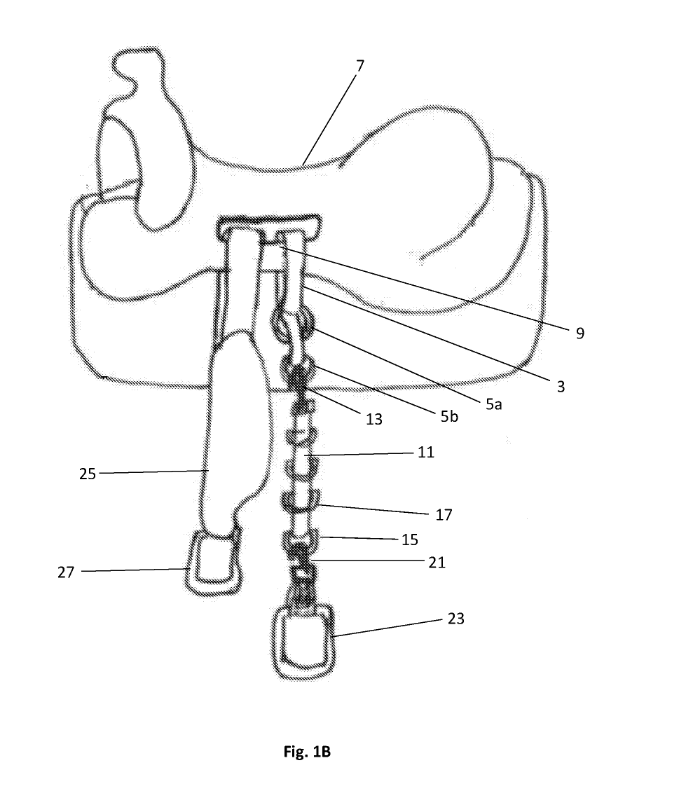

The present invention comprises a secondary saddle stirrup system comprised of the components as shown in FIGS. 1A-B. The secondary saddle stirrup system can be comprised of a removable saddle anchor 1. The saddle anchor 1 can have a strap portion 3 with first end 2 and a second end 4. The strap portion 3 can be comprised of any suitable material capable of supporting the weight of a rider, such as nylon, Kevlar, or leather. One exemplary embodiment uses a nylon strap with a breaking strength greater than about 1,000 pounds. Similarly, leather can be used for the strap portion of the saddle anchor. The saddle anchor 1 can be coupled to various accessories that can be attached to various parts of a saddle 7. In one exemplary embodiment, the saddle anchor 1 is coupled to the saddle tree 9, which is located underneath the leather coverings of the saddle 7. This provides a reliable anchoring position for the saddle anchor 1 because the saddle tree 9 makes up the base of the saddle 7. Other locations to attach or couple the saddle's anchor 1 can include the saddle pommel and rigging dee, among others.

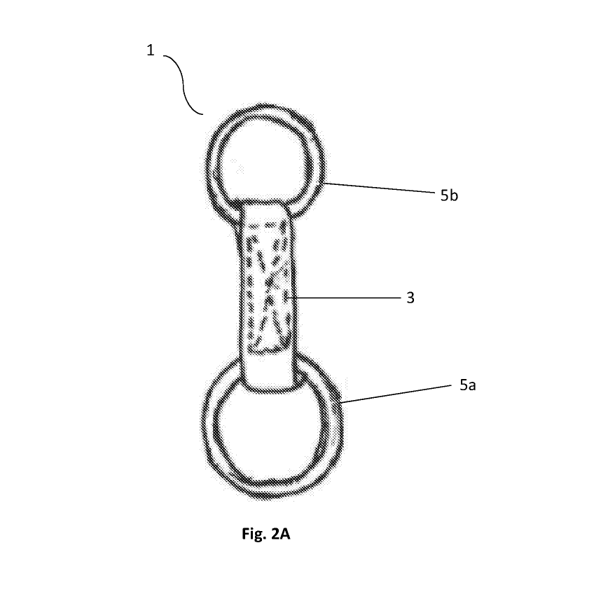

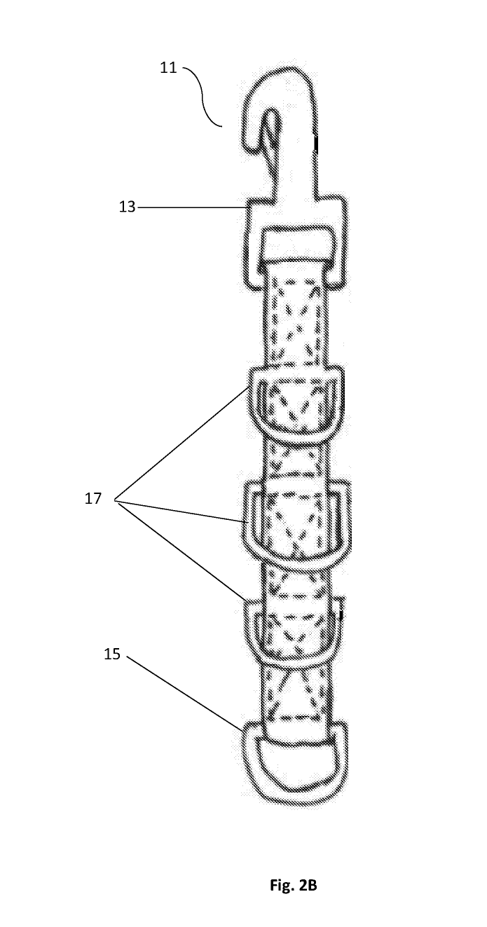

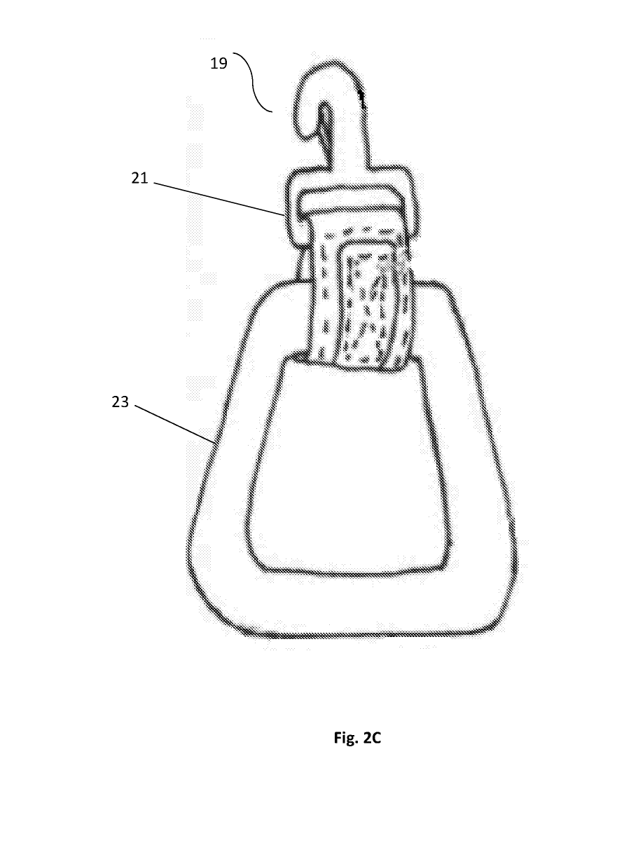

As further illustrated in FIG. 2A, both the first end 2 and the second end 4 can each have a coupling member 5a and 5b, such as a ring or loop connected to the strap portion 3. In one exemplary embodiment, one of the rings or loops can be a coupling member, such as a snap. The snap can be small enough to fit through the inner diameter of a ring coupled to the strap portion. Any suitable means can be used to connect the rings 5a and 5b to the ends of the strap, such as looping a portion of the strap portion 3 around the rings 5a and 5b, and using high tensile strength stitching to hold the rings 5a and 5b within the strap 3. The rings can be composed of any suitable material such as steel and can be welded to provide extra strength. In some embodiments the rings can be D-rings. In one exemplary embodiment, one of the rings 5a can be a larger ring than the other ring 5b. The rings 5a,b are connected and secured to the ends of the strap by the strap portion having a loop at the end that has been stitched to secure the ring to the end of the strap portion 3.

In one exemplary embodiment the inner diameter of the large ring 5a is greater than the outer diameter of the small ring 5b, such that the small ring 5b is capable of fitting through the inner diameter of the large ring 5a. This enables user to easily attach the saddle anchor 1 to the desired component of the saddle 7 by looping the strap portion around the desired component and threading the small ring through the large ring to form an anchorage tie off on the saddle 7. The saddle anchor 1 provides an accessible anchor point to which additional components of the secondary stirrup system of the present invention may attach. The saddle anchor provides an apparatus that can be attached during the original manufacture of saddles, while also allowing for easy adaptability and use with almost any pre-existing saddle. In one exemplary embodiment of the present invention, the saddle anchor 1 is attached to a stirrup bar. In yet another exemplary embodiment, the saddle anchor is attached to a rear ring of the saddle. The saddle anchor can also be attached directly to a saddle tree 9. As noted, by attaching the saddle anchor 1 to the saddle tree 9 of a saddle 7, the system can better disperse the pressure applied when the system is in use across the entire saddle and not a single point that may otherwise result in damage to or failure of the saddle 7.

As shown in FIG. 2B, the system can further include a removable stirrup strap 11 that can be coupled to the saddle's anchor 1. The stirrup strap 11 can be made of any suitable material including, but not limited to, the same materials as the saddle anchor. The stirrup strap has a first end 12 and a second end 14. The first end 12 of the stirrup strap can have a coupler 13. In one exemplary embodiment of the present invention, the coupler 13 is a snap coupler, such as a bull snap as seen in FIG. 2B. The second end 14 of the stirrup strap can have a coupling ring 15 coupled thereto, such as a D ring. Alternatively, both the first end 12 and second end 14 can have either a coupling ring 15 or a coupler 13 or both. Additionally, there can be a plurality of additional coupling points 17 between the first end 12 and second end 14 of the stirrup strap 11. In one exemplary embodiment, the coupling points can be comprised of similar rings, wherein the rings are coupled to the stirrup strap 11 between the first end 12 and the second end 14. The coupling points 17 can be attached to the stirrup strap at pre-determined locations along the stirrup strap 11. In another exemplary embodiment, the coupling points 17 can be a snap coupled to the stirrup strap 11.

The system can also include a removable stirrup 19 as shown in FIG. 2C. The stirrup 19 can have a stirrup coupler 21 attached to the foot loop portion 23 of the stirrup 19. The stirrup coupler 21 can be removably coupled to the coupling ring 15 or other coupling points 17 of the stirrup strap 11. Similar to the coupler 13 of the stirrup strap 11, the coupler 13 of the stirrup 19 can be a snap, such as a bull snap shown in FIG. 2C. In another exemplary embodiment, the stirrup coupler 21 can be a ring, such as a D ring. The multiple coupling points 17 on the stirrup strap 11 and the stirrup coupler 21 enables a user to quickly adjust the height of the stepping point of the stirrup without the burden of adjusting a belt latch found on traditional stirrups and stirrup attachments. Additionally, belt latches can be points of failure in current stirrup equipment. This gives a user easier means for adjusting the height of the stirrup and caters to each individual user's needs. This is particularly helpful in situations where the user of the saddle changes frequently, such as on guest ranches and other commercial horse riding businesses. Instead of the stirrup strap 11 being adjusting in length, the coupling points 17 act as an adjustment means, allowing a user to quickly and effortlessly couple the stirrup 11 to the coupling points 17 or ring 15 at the preferred height desired by the user.

The foot loop 23 of the secondary stirrup 19 can have a friction surface to allow a user to get a better footing when stepping into the foot loop 23. The foot loop 23 can be composed of any suitable material, including wood, polymer or metal. The coupling points 17 located on the stirrup strap 11 allow a user to easily adjust the height of the stirrup's foot hole by coupling the stirrup coupler 21 of the stirrup 19 to the appropriate coupling point 17 for the desired height. This is a substantial increase in efficiency rather than having to adjust a buckle or similar fastener. This allows multiple users to adjust the height of the secondary stirrup 19 in less than 20 seconds, such as less than about 15 seconds, such as less than about 10 seconds. It also provides a more durable system than known belt buckle systems, which can fail under heavier loads. In one exemplary embodiment, the foot loop and stirrup coupler 21 are attached to each other using any suitable means. As shown in FIG. 2C, a strap material can be used to couple the stirrup coupler 21 to the foot loop 23.

The secondary stirrup system of the present invention provides a lift aid for mounting a horse. The foot loop 23 of the secondary stirrup system provides an easy step to assist a user to step into the primary stirrup 25 of the saddle 7. The foot loop 23 of the secondary stirrup system sits below and nearer to the rear of the saddle 7 than the primary stirrup 25. This allows a user an easy assist to mounting the horse by stepping into the secondary stirrup's foot hole 23 and the step into the foot hole 27 of the primary stirrup 25 before the user throws their leg over the saddle on the horse. This allows a user to mount the horse in two small steps, rather than a big step as in a conventional saddle. After mounting the horse, a user can easily detach the stirrup strap 11 from the saddle anchor 1, at which point the stirrup strap 11 and stirrup 19 can be stowed away in a saddle bag or any other suitable location so as to not impede the horse's movement. Similarly, the stirrup coupler 21 can be used to couple the second end 14 of the stirrup strap 11 along with the stirrup 19 to the saddle anchor 1 or the first end 12 of the stirrup strap 11 to hold the secondary stirrup system while the secondary stirrup system is not in use.

All of the ring and strap portions of the present invention can be of any suitable material to support the weight of a rider, such as nylon or leather. The rings of the stirrup strap 11 and the saddle anchor 1 can be bound to their respective strap sections by using a loop feature in the straps and stitching them with a suitable stitching material such as nylon or Kevlar. The couplers of the stirrup and stirrup strap can also be attached by a similar means. Additionally, it is understood that couplers and rings can be substituted for each other in various embodiments of the invention.

The secondary stirrup system substantially reduces the skill, coordination, and strength otherwise required in mounting a horse with a conventional saddle. The secondary stirrup system is portable, collapsible, lightweight, weatherproof, and can be easily installed or removed from a saddle.

A plurality of saddle anchors 1 can be attached to the saddle to provide additional coupling points for additional attachments, including but not limited to additional stirrups, saddle bags, and other accessories. In one exemplary embodiment a saddle 7 can have a saddle anchor 1 coupled to each side of the saddle 7 on the saddle tree 9. A stirrup strap 11 or other similar strap can be coupled to each of the saddle anchors 1. The stirrup straps 11 can further have stirrups 19 attached to each stirrup strap 11. In yet another exemplary embodiment the stirrup strap and stirrups can be one combined unit.

The use of multiple saddle anchors can be advantages and used in place of “buddy straps” that traditionally attach to the horn of a saddle for use by youth riders whose legs cannot reach the attached stirrups of the saddle. In this embodiment, two secondary stirrup systems are used to provide stirrups for a youth or shorter user. Two saddle anchors 1 can be used on each side of the saddle tree 9, wherein a stirrup strap 11 and stirrup 19 can be coupled to each side. This can allow a youth user to have their feet placement with respect to the saddle 7 more underneath them and in a traditional riding position as opposed to far out in front of their bodies when using traditional buddy straps. This can provide greater stability while on top of the horse and can aid in preventing a user from falling off of the saddle.

The secondary stirrup system of the present invention can be used for mounting and dismounting a horse. One method of using the secondary saddle stirrup system comprises first providing a saddle anchor, stirrup strap, and a stirrup. A user can then couple the saddle anchor to a saddle. The stirrup strap can then be coupled to the saddle anchor. A user can then determine the appropriate height and which coupling point to use for coupling the stirrup to the stirrup strap. The stirrup can then be coupled to the stirrup strap. A user can then mount the horse and decouple the stirrup strap and stow away the stirrup strap and stirrup while riding. Alternatively, a user can use two of the secondary stirrup systems to be used while riding.

The invention has been shown and described above with the preferred embodiment, and it is understood that many modifications, substitutions, and additions may be made which are within the intended spirit and scope of the invention. From the foregoing, it can be seen that the present invention accomplishes at least all of its stated objectives.

What is claimed is:

1. A secondary saddle stirrup system comprising:
a saddle anchor configured to be removably coupled to a portion of a saddle;
a stirrup strap configured to be removably coupled to said saddle anchor; and
a stirrup coupled to said stirrup strap.

2. The system of claim 1, wherein said saddle anchor has a first end and a second end, wherein said first end has a first ring and a second ring each having an inner diameter and an outer diameter, wherein said inner diameter of first ring is greater than said outer diameter of the second ring.

3. The system of claim 1, wherein said stirrup is configured to be removably coupled to said stirrup strap.

4. The system of claim 1, wherein said stirrup strap has a first end and a second end, wherein said first end has a coupler and said second end has a ring.

5. The system of claim 4, wherein said stirrup strap has one or more coupling points between said first end and second end.

6. The system of claim 5, wherein said coupling point is a d-ring coupled to said stirrup strap.

7. The system of claim 1, wherein said saddle anchor is further configured to disperse pressure over said saddle.

8. The system of claim 1, wherein said portion of the saddle is a saddle tree.

9. The system of claim 1, wherein said stirrup has a foot hole portion and a coupler portion.

10. The system of claim 4, wherein said coupling point is a snap.

11. The system of claim 1, wherein said stirrup further comprises a foot hole portion and a coupler portion.

12. The system of claim 11, wherein said foot hole portion further comprises a friction surface configured to better grip a user's foot.

13. The system of claim 2, wherein a stirrup strap further comprises a first end and a second end, wherein said first end has a coupler and said second end has a ring; and
said stirrup is configured to be removably coupled to said stirrup strap, and further comprises a foot hole portion and a coupler portion, wherein said coupler potion is configured to be removably coupled to said stirrup strap.

14. The system of claim 13, wherein said foot hole portion further comprises a friction member.

15. A saddle anchor configured to couple to a saddle tree of a saddle, comprising:
a first end and a second end, wherein said first end has a first coupling member and a second coupling member.

16. The saddle anchor of claim 15, wherein said first and second coupling member are rings each having an inner diameter and an outer diameter, wherein said inner diameter of first coupling member is greater than said outer diameter of the second coupling member.

17. The saddle anchor of claim 15, wherein said first coupling member is a snap and second coupling member is a ring having an inner diameter, wherein said snap is configured to fit within the inner diameter of said ring.

18. A method of providing an secondary saddle stirrup system to a saddle having a saddle tree, comprising the steps of:
providing a saddle anchor, stirrup strap, and a stirrup;
coupling said saddle anchor to a saddle;
coupling a stirrup strap to said saddle anchor;
determining appropriate height to couple said stirrup to said stirrup strap; and
coupling said stirrup to said stirrup strap.

19. The method of claim 18, wherein said saddle anchor is coupled to a portion of the saddle tree.
